(19) United States
(12) Patent Application Publication
(10) Pub. No.: US 2026/0068951 A1
(43) Pub. Date: Mar. 12, 2026

(54) AEROSOL GENERATING APPARATUS AND METHOD OF CONTROLLING AEROSOL GENERATING APPARATUS

(71) Applicant: KT&G CORPORATION, Daejeon (KR)

(72) Inventors: Jin Chul JUNG, Daejeon (KR); Han Yong LEE, Seoul (KR); Jung Ho KIM, Seoul (KR); Sang Cheol PARK, Suwon-si (KR); Jang Won SEO, Yongin-si (KR); Won Kyeong LEE, Guri-si (KR); Chul Ho JANG, Bucheon-si (KR)

(73) Assignee: KT&G CORPORATION, Daejeon (KR)

(21) Appl. No.: 19/279,379

(22) Filed: Jul. 24, 2025

(30) Foreign Application Priority Data
Sep. 12, 2024 (KR) 10-2024-0124901
Dec. 3, 2024 (KR) 10-2024-0177902

(51) Int. Cl. A24F 40/53; A24F 40/20; A24F 40/42; A24F 40/46; A24F 40/51; A24F 40/57; A24F 40/65; H05B 6/68

(52) U.S. Cl. CPC A24F 40/53; A24F 40/46; A24F 40/57; H05B 6/686; A24F 40/20; A24F 40/42; A24F 40/51; A24F 40/65

(57) ABSTRACT

Provided are an aerosol generating apparatus and a method of controlling the aerosol generating apparatus. The aerosol generating apparatus includes a source unit configured to generate a microwave signal to perform dielectric heating on an aerosol generating article by using microwaves, and a control unit configured to control an intensity of the microwave signal by controlling powers to be provided from a power source to the source unit, wherein the control unit includes a processor, which is configured to monitor power feedback data on powers provided to the source unit while the dielectric heating is performed with a preset power profile during a smoking session, and to update the power profile based on the monitored power feedback data when calibration of target powers of the power profile is necessary.

### CROSS-REFERENCE TO RELATED APPLICATIONS

This application is based on and claims priority under 35 U.S. C. § 119 to Korean Patent Application No. 10-2024-0124901, filed on Sep. 12, 2024, and 10-2024-0177902, filed on Dec. 3, 2024, in the Korean Intellectual Property Office, the disclosure of which are incorporated by reference herein in their entirety.

### BACKGROUND

### 1. Field

The disclosure relates to an aerosol generating apparatus and a method of controlling the aerosol generating apparatus, and more particularly, to a method by which an aerosol generating apparatus updates a power profile that is used to perform dielectric heating.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes. Accordingly, research on heating-type aerosol generating devices has been actively conducted.

However, a heating type aerosol generating apparatus corresponds to a device that uses high power for a heating operation, and thus, efficient use of a battery is required. In addition, precise control of a heating temperature is required to provide a satisfactory smoking experience to a user. Accordingly, measures are required to optimize, for an aerosol generating apparatus, a power profile used for controlling heating.

### SUMMARY

An aerosol generating apparatus generates an aerosol by performing heating control according to a preset power profile. However, due to factors such as a usage pattern of the aerosol generating apparatus or a surrounding environment, the performance of heating control may be reduced only by using the preset power profile. Thus, a measure is required to improve efficiency and performance of heating control by performing precise power control of the aerosol generating apparatus. The technical objective of the disclosure is not limited to that described above, and other technical objectives may be inferred from embodiments described below.

Additional aspects will be set forth in part in the description which follows and, in part, will be apparent from the description, or may be learned by practice of the presented embodiments of the disclosure.

In an aerosol generating apparatus according to the disclosure, a function of updating a power profile may be employed to thereby improve power usage efficiency and enable precise heating control.

According to an embodiment, an aerosol generating apparatus includes a source unit configured to generate a microwave signal to perform dielectric heating on an aerosol generating article by using microwaves, and a control unit configured to control an intensity of the microwave signal by controlling powers to be provided from a power source to the source unit, wherein the control unit includes a processor, which is configured to monitor power feedback data on powers provided to the source unit while the dielectric heating is performed with a preset power profile during a smoking session, and to update the power profile based on the monitored power feedback data when calibration of target powers of the power profile is necessary.

According to another embodiment, a method of controlling an aerosol generating apparatus includes, when a smoking session is initiated, setting a power profile to perform dielectric heating on an aerosol generating article by using microwaves, monitoring power feedback data on powers provided to a source unit configured to generate a microwave signal, while the dielectric heating is performed with the set power profile during the smoking session, when the smoking session has ended, determining whether calibration of the power profile is necessary, based on the monitored power feedback data, and when it is determined that the calibration of the power profile is necessary, updating the power profile based on the monitored power feedback data.

According to another embodiment, a non-transitory computer-readable storage medium has recorded thereon a program for executing the method described above, on a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating apparatus according to an embodiment;

FIG. 2 is a diagram for describing a power profile according to an embodiment;

FIG. 3 is a diagram for describing a method of generating a power profile to be used in an aerosol generating apparatus, according to an embodiment;

FIG. 4 is a diagram in which a preset power profile is compared with a change in a power supply during actual smoking, when dielectric heating is performed in an aerosol generating apparatus, according to an embodiment;

FIG. 5 is a flowchart for describing a method of calibrating a power profile, according to an embodiment;

FIG. 6 is a diagram for describing a method of determining whether it is necessary to calibrate a power profile, according to an embodiment;

FIG. 7 is a diagram for describing a power profile that is updated through calibration, according to an embodiment; and

FIG. 8 is a diagram for describing a method of setting an update function for a power profile, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory) readable by a machine (e.g., an aerosol generating device 1). For example, a processor (e.g., a controller 170) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

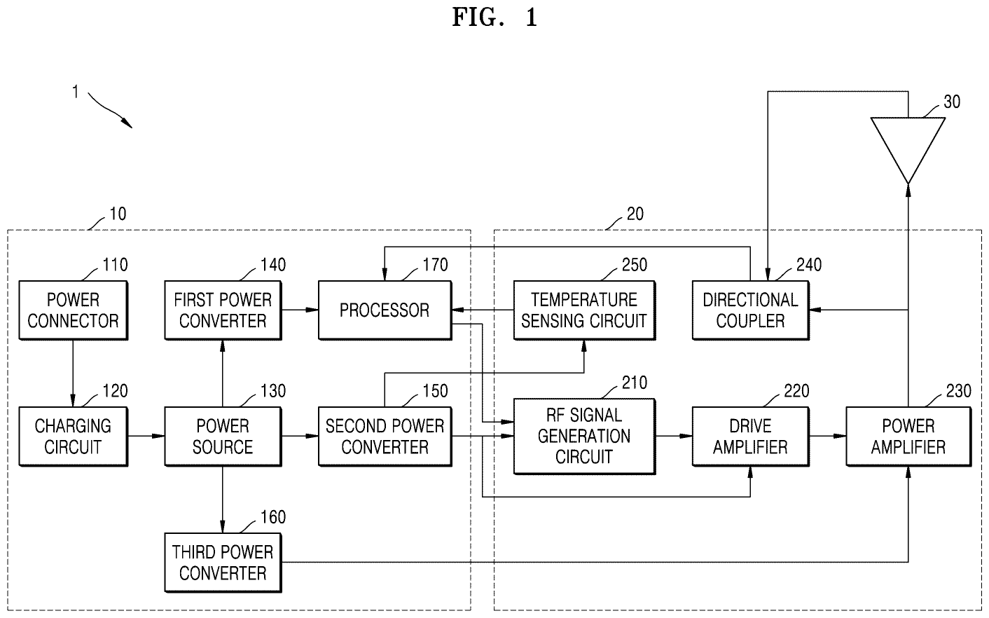

FIG. 1 is a block diagram of an aerosol generating device 1 according to an embodiment.

According to an embodiment, the aerosol generating device 1 may include a control unit 10, a source unit 20, and a radiating unit 30. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 130, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 1 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 130). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 130. The charging circuit 120 may charge the power supply 130 by using power transmitted from the power connector 110. In an example, the charging circuit 120 may be implemented as a charger IC, which is an integrated circuit (IC) that performs functions for efficiently and safely charging the power supply 130. The charging circuit 120 may monitor the charging status of the power supply 130 or optimize the charging process by monitoring the voltage, current, and/or temperature of the power supply 130. For example, the charging circuit 120 may detect the status of the power supply 130 and prevent overcharging or overdischarging by providing an appropriate charging voltage and current.

The power supply 130 may supply power for the operation of the aerosol generating device 1. The power supply 130 may include one or more rechargeable batteries. The power supply 130 may supply power to the radiating unit 30 such that the radiating unit 30 may radiate electromagnetic waves (e.g., RF signals) into the insertion space to heat an aerosol-generating article. Here, power supply to the radiating unit 30 may indicate power supply to the source unit 20. Additionally, the power supply 130 may supply power required for the operation of the processor 170, the RF signal generation circuit 210, the drive amplifier 220, the power amplifier 230, the temperature sensing circuit 250, etc. In an example, the power supply 130 may include, but is not limited to, a lithium polymer (LiPoly) battery. The power supply 130 may be a replaceable type (separated type) battery (hereinafter, a removable battery). The removable battery may be mounted in a battery holder provided within the aerosol generating device 1 or removed from the battery holder. The removable battery may be charged in a wired manner and/or wirelessly.

The aerosol generating device 1 may include a power conversion circuit for converting power supplied from the power supply 130 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V/25 W) suitable for the power amplifier 230.

However, the first power converter 140, the second power converter 150, and the third power converter 160 are not limited to the examples described above and may include other types of power conversion circuits. Additionally, although FIG. 1 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 130 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontroller unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 130 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz. In the present embodiments, the RF signal may also be referred to as electromagnetic waves, microwaves, or the like.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 1, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g. SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space. For the heating efficiency of the aerosol generating article to be maximized, resonance of electromagnetic waves is to occur within the insertion space. The resonance conditions (e.g., resonant frequency) of the insertion space may vary depending on the type or the amount of dielectric contained in the inserted aerosol-generating article. The processor 170 may control the frequency of an RF signal generated by the RF signal generation circuit 210 to correspond to or be close to the resonance condition of the insertion space by adjusting a control signal input to the RF signal generation circuit 210. The processor 170 may use the directional coupler 240 to obtain information about the resonance conditions of the insertion space.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Since resonance of electromagnetic waves may occur in the insertion space depending on the frequency of the RF signal, the insertion space may be referred to as a resonant section. At least a portion of the insertion space may be surrounded by at least one shielding member to prevent electromagnetic waves from leaking outside the aerosol generating device 1. In an embodiment, the insertion space may further include a physical structure to ensure that the resonance conditions are within a range controllable by the processor 170. The physical structure may include at least one conductor, and the resonance conditions of the insertion space may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that are to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, if the aerosol generating device 1 is a hybrid type device that uses both an aerosol-generating article and a cartridge, the aerosol generating device 1 may further include a cartridge heater. The cartridge heater may receive power from the power supply 130 to heat a medium and/or an aerosol-generating material within the cartridge.

According to an embodiment, the sensor unit may detect the status of the aerosol generating device 1 or the status around the aerosol generating device 1 and transmit the detected information to the processor 170. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol-generating article. The temperature sensor may be positioned in contact with or adjacent to the insertion space or the aerosol-generating article to directly measure the temperature of the insertion space or the aerosol-generating article. Additionally, the temperature sensor may be positioned to be spaced apart from the insertion space or the aerosol-generating article to indirectly measure the temperature of the insertion space or the aerosol-generating article (e.g., in a non-contact manner). In an example, the temperature sensor may include an optical temperature sensor (e.g., an infrared temperature sensor).

In an embodiment, the temperature sensor may detect the temperature of the power supply 130. The temperature sensor may be arranged adjacent to the power supply 130. For example, the temperature sensor may be attached to one surface of the power supply 130 (e.g., a battery) and/or mounted on one surface of a printed circuit board. For example, the aerosol generating device 1 may include a protection circuit module (PCM), and the temperature sensor may be positioned adjacent to the power supply 130 together with the PCM.

According to an embodiment, the temperature sensor may be arranged inside the housing (not shown) of the aerosol generating device 1 to detect the temperature inside the housing (not shown).

In an embodiment, the puff sensor may detect a user's puff.

As an example, the puff sensor may include a pressure sensor. The pressure sensor may output a signal corresponding to the internal pressure of the aerosol generating device 1, and the processor 170 may detect a user's puff based on the signal corresponding to the internal pressure. The internal pressure of the aerosol generating device 1 may correspond to pressure of an airflow path on which gas flows. The puff sensor may be disposed to correspond to the airflow path, through which gas flows, in the aerosol generating device 1.

In another example, the puff sensor may include a temperature sensor. When a user puffs, a temporary temperature drop may occur in the airflow path, the insertion space, the aerosol generating article, etc. The processor 170 may detect the user's puff based on a signal corresponding to the temperature of an airflow path, etc. output from a temperature sensor.

In another example, the puff sensor may include both a pressure sensor and a temperature sensor. In this case, the temperature sensor may measure the temperature which is used to correct the internal pressure measured by the pressure sensor. For example, the puff sensor may correct a signal corresponding to internal pressure based on a temperature measured by the temperature sensor and output the corrected signal. In another example, the puff sensor may output a signal corresponding to a temperature measured by the temperature sensor and a signal corresponding to the internal pressure measured by the puff sensor. In this case, the processor 170 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When a user puffs, temperature changes and/or aerosol flow may occur within the insertion space, thereby changing the permittivity within the insertion space. The processor 170 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of an aerosol-generating article. The insertion detection sensor may be installed around the insertion space.

As an example, the insertion detection sensor may include a capacitive sensor. The capacitive sensor may include at least one conductor, wherein the at least one conductor may be positioned adjacent to the insertion space. When an aerosol generating article is inserted or removed within the insertion space, the permittivity around the conductor may change. The processor 170 may detect insertion and/or removal of an aerosol-generating article based on a signal corresponding to the permittivity inside the insertion space output from the capacitive sensor.

In another example, the insertion detection sensor may include an inductive sensor. The inductive sensor may include at least one coil, wherein the at least one coil may be positioned adjacent to the insertion space. When an aerosol-generating article (e.g., a wrapper for the aerosol-generating article) contains a conductor, a change in the magnetic field may occur around the current-carrying coil when the aerosol-generating article is inserted into or removed from the insertion space. The processor 170 may detect insertion and/or removal of an aerosol-generating article including a conductor based on characteristics of a current output from or detected by an inductive sensor (e.g., frequency of an alternating current, current value, voltage value, inductance value, impedance value, etc.). Alternatively, the aerosol-generating article (e.g., the medium portion of the aerosol-generating article) may include a susceptor (e.g., SUS). Even in this case, a change in the magnetic field around the coil may occur based on the insertion or removal of a susceptor or the like within the insertion space, and the processor 170 may also detect the insertion and/or removal of the aerosol-generating article based on the characteristics of the current of the inductive sensor.

The insertion detection sensor is not limited to the examples described above and may be implemented using various sensors (e.g., proximity sensors, etc.) for detecting insertion and/or removal of an aerosol-generating article. Additionally, the insertion detection sensor may include any combination of the examples described above. In an embodiment, the insertion detection sensor may include a switch or the like for detecting compression by an aerosol-generating article.

In an embodiment, the reuse detection sensor may detect whether an aerosol-generating article has been reused. As an example, the reuse detection sensor may be a color sensor for detecting the color of the aerosol generating article. When the aerosol-generating article is used by a user, a change in color of a portion of the wrapper surrounding the outside of the aerosol-generating article may occur due to the generated aerosol or heating. The color sensor may output a signal corresponding to optical characteristics (e.g., wavelength of light) corresponding to the color of the wrapper based on light reflected from the wrapper. The processor 170 may determine that the aerosol-generating article inserted into the insertion space has already been used if a change in color of a portion of the wrapper is detected.

In an embodiment, the overly moist detection sensor may detect whether the aerosol-generating article is overly moist. For example, the overly moist detection sensor may include a capacitive sensor. The capacitive sensor may include at least one conductor positioned adjacent to the insertion space. The processor 170 may detect whether the aerosol-generating article is overly moist, based on the level of a signal corresponding to a permittivity or the like output from the capacitive sensor. For example, the processor 170 may determine a level range within which the level of the signal is included, based on a look-up table, and determine the moisture content of the aerosol-generating article based on the determined level range.

In an embodiment, the cigarette identification sensor may detect whether the aerosol-generating article is authentic and/or detect the type of the aerosol-generating article.

As an example, the cigarette identification sensor may include an optical sensor for detecting an identification material (or identification tag) located on an outer surface of an aerosol-generating article (e.g., a wrapper). The optical sensor may irradiate light toward the identification material (or identification mark) of the aerosol-generating article and detect, based on the reflected light, the authenticity and/or type of the aerosol-generating article. For example, the identification material may include a material that emits light of a particular wavelength, based on the irradiated light. The processor 170 may detect whether the aerosol-generating article is authentic and/or the type of the article based on the range of the wavelength.

In another example, the cigarette identification sensor may include a capacitive sensor. Depending on the type of aerosol generating article inserted into the insertion space, the permittivity inside the insertion space may vary. The processor 170 may detect whether the aerosol generating article is authentic and/or the type thereof based on a signal corresponding to the permittivity inside the insertion space output from the capacitive sensor.

In another example, the cigarette identification sensor may include an inductive sensor. When a conductor is included in a wrapper and/or interior (e.g., medium portion) of an aerosol-generating article inserted into the insertion space, the characteristics of the current detected by the inductive sensor (e.g., frequency of AC current, current value, voltage value, inductance value, impedance value, etc.) may differ depending on the type of the aerosol-generating article inserted into the insertion space. The processor 170 may detect whether the inserted aerosol-generating article is authentic and/or the type thereof based on the characteristics of the current output from or detected by the inductive sensor.

The cigarette identification sensor is not limited to the examples described above and may be implemented using various sensors to detect whether the aerosol-generating article is authentic and/or to detect the type of the aerosol-generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, the cap detection sensor may detect attachment and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of a cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 170 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

According to an embodiment, the sensor unit may further include, in addition to the sensors described above, at least one of a humidity sensor, an atmospheric pressure sensor, a magnetic sensor, a position sensor (global positioning system (GPS)), or a proximity sensor. The functions of the sensors would be instinctively understood by one of ordinary skill in the art in view of their names and thus detailed descriptions thereof are omitted herein.

According to an embodiment, the output unit may output information about the status of the aerosol generating device 1. The output unit may include, but is not limited to, a display, a haptic unit, and/or an audio output unit. For example, information about the aerosol generating device 1 may include the charging/discharging status of the power supply 130 of the aerosol generating device 1, the operating status of the source unit 20 or the radiating unit 30, the insertion/removal status of the aerosol-generating article and/or cartridge, the mounting and/or removal status of the cap, or the status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. The display, if the display includes a touchpad, may also be used as an input device. The haptic unit may provide tactile information to the user about the status of the aerosol generating device 1. For example, the haptic component may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

According to an embodiment, the input unit may receive information input from a user. For example, the input unit may include a touch panel, a button, a key pad, a dome switch, a jog wheel, a jog switch, and the like.

According to an embodiment, the memory may be hardware that stores various data processed within the aerosol generating device 1, and may store data processed by the processor 170 and data to be processed. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about the operation time of the aerosol generating device 1, the maximum number of puffs, the current number of puffs, at least one temperature profile, and the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near field Communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+communication unit, a cellular network communication unit, an Internet communication unit, a computer network (e.g., LAN or WAN) communication unit, etc.

According to an embodiment, the processor 170 may control the temperature of the insertion space or the aerosol-generating article by controlling an amplification factor of the source unit 20 (e.g., the power amplifier 230). The processor 170 may control the amplification factor of the source unit 20 (e.g., the power amplifier 230) based on the temperature of the insertion space or the aerosol-generating article detected using the temperature sensor. The processor 170 may control the amplification factor of the source unit 20 (e.g., the power amplifier 230) based on the temperature profile and/or power profile stored in the memory.

Additionally, the processor 170 may control the temperature of the cartridge heater by controlling the supply of power from the power supply 130 to the cartridge heater. The processor 170 may control the temperature of the cartridge heater and/or power supplied to the cartridge heater, based on the temperature of the cartridge heater detected using the temperature sensor. The processor 170 may control the temperature of the cartridge heater and/or the power supplied to the cartridge heater based on the temperature profile and/or power profile stored in the memory.

In an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol-generating article, and/or the cartridge heater exceeds a preset threshold temperature.

According to an embodiment, the processor 170 may control power supply to the source unit 20 or the cartridge heater, based on a result detected by the sensor unit.

In an embodiment, the processor 170 may control power supply to the source unit 20 or the cartridge heater based on insertion and/or removal of the aerosol-generating article into the insertion space. For example, the processor 170 may control power to be supplied to the source unit 20 or the cartridge heater when it is determined that the aerosol-generating article has been inserted into the insertion space using the insertion detection sensor. The processor 170 may cut off the power supply to the source unit 20 or the cartridge heater if it is determined that the aerosol-generating article has been removed from the insertion space using the insertion detection sensor. The processor 170 may determine that the aerosol-generating article has been removed from the insertion space, if the temperature of the insertion space or the aerosol-generating article is above a limited temperature or if the temperature change gradient of the insertion space or the aerosol-generating article is equal to or above a set gradient.

In an embodiment, the processor 170 may control the power supply time and/or power supply amount of power supplied to the source unit 20 or the cartridge heater, based on the state of the aerosol-generating article. For example, the processor 170 may increase the power supply time (e.g., preheating time) of power supply to the source unit 20 or the cartridge heater, if it is determined that the aerosol-generating article is in an overly moist state by using the overly moist detection sensor.

In an embodiment, the processor 170 may control power supply to the source unit 20 or the cartridge heater based on whether the aerosol-generating article is to be reused. For example, the processor 170 may cut off power supply to the source unit 20 or the cartridge heater if it is determined that the aerosol-generating article has been used.

In an embodiment, the processor 170 may control power supply to the source unit 20 or the cartridge heater, based on whether the cartridge is engaged and/or removed. For example, the processor 170 may stop supplying power to the source unit 20 or the cartridge heater or control power not to be supplied to the source unit 20 or the cartridge heater if it is determined, by using the cartridge detection sensor, that the cartridge is removed.

In an embodiment, the processor 170 may control power supply to the source unit 20 or the cartridge heater based on whether the aerosol-generating material in the cartridge has been exhausted. For example, the processor 170 may determine that the aerosol-generating material in the cartridge is exhausted if it is determined that the temperature of the cartridge heater exceeds a limit temperature while preheating the cartridge heater (i.e., during the preheating period). If it is determined that the aerosol-generating material in the cartridge has been exhausted, the processor 170 may cut off the supply of power to the source unit 20 or the cartridge heater.

In an embodiment, the processor 170 may control power supply to the source unit 20 or the cartridge heater based on the availability of the cartridge. For example, the processor 170 may determine that the cartridge is no longer usable if it is determined that the current number of puffs is equal to or greater than the maximum number of puffs set for the cartridge based on data stored in the memory. Alternatively, the processor 170 may determine that the cartridge is unusable if the total time that the cartridge heater has been heated is equal to or greater than a preset maximum time or the total amount of power supplied to the cartridge heater is equal to or greater than a preset maximum amount of power. In this case, the processor 170 may stop supplying power to the source unit 20 or the cartridge heater or control power not to be supplied to the source unit 20 or the cartridge heater.

In an embodiment, the processor 170 may control power supply to the source unit 20 or the cartridge heater based on the user's puff. For example, the processor 170 may use a puff sensor to determine whether a puff has occurred and/or the intensity of the puff. The processor 170 may cut off the power supply to the source unit 20 or the cartridge heater if the number of puffs reaches a preset maximum number of puffs and/or if no puffs are detected for a preset period of time. The processor 170 may also control the supply of power to the source unit 20 or the cartridge heater when a puff is detected.

In an embodiment, the processor 170 may control power supply to the source unit 20 or the cartridge heater based on the authenticity and/or type of the aerosol-generating article (or the cartridge). For example, the processor 170 may use the cigarette identification sensor to detect the authenticity and/or type of the aerosol-generating article (or the cartridge). For example, the processor 170 may cut off power supply to the source unit 20 or the cartridge heater if the aerosol-generating article (or the cartridge) is detected to be counterfeit. The processor 170 may control (e.g., initiate) the supply of power to the source unit 20 or the cartridge heater when the aerosol-generating article (or the cartridge) is detected to be authentic. In another example, the processor 170 may control power supply to the source unit 20 or the cartridge heater differently depending on the type of the aerosol-generating article (or the cartridge). The processor 170 may control the amplification factor of the source unit 20 or the temperature and/or power of the cartridge heater, based on a first temperature profile (or a first power profile) when the aerosol-generating article (or the cartridge) is detected to be a first aerosol-generating article (or a first cartridge), and may control the amplification factor of the source unit 20 or the temperature and/or power of the cartridge heater, based on a second temperature profile (or a second power profile) when the aerosol-generating article (or the cartridge) is detected to be a second aerosol-generating article (or a second cartridge).

According to an embodiment, the processor 170 may control the output unit based on a result detected by the sensor unit. For example, the processor 170 may control the output unit to provide visual, tactile and/or auditory information indicating that the aerosol generating device 1 is about to be terminated, when the number of puffs counted using the puff sensor reaches a preset number. For example, the processor 170 may control the output unit to provide visual, tactile and/or auditory information about the temperature of the insertion space, the aerosol-generating article, or the cartridge heater.

According to an embodiment, the processor 170 may store and update a history of events that occurred in the memory based on the occurrence of a given event. For example, the event may include operations such as detection of insertion of an aerosol-generating article, initiation of heating of an aerosol-generating article, detection of a puff, termination of a puff, detection of overheating, detection of overvoltage application to a cartridge heater, termination of heating of an aerosol-generating article, turning on/off power of the aerosol generating device 1, initiation of charging of the power supply 130, detection of overcharge of the power supply 130, termination of charging of the power supply 130, etc., performed in the aerosol generating device 1. For example, the history of events may include the time an event occurred, log data corresponding to the event, etc. For example, if a given event is detection of insertion of an aerosol-generating article, log data corresponding to the event may include data about sensing values of an insertion detection sensor, etc. For example, if a given event is overheating detection of a cartridge heater, log data corresponding to the event may include data about a temperature of the cartridge heater, a voltage applied to the cartridge heater, a current flowing through the cartridge heater, etc.

According to an embodiment, the processor 170 may control the communication unit to form a communication link with an external device, such as a user's mobile terminal.

According to an embodiment, the processor 170 may release a restriction on the use of at least one function (e.g., a heating function) of the aerosol generating device 1 when data regarding authentication is received from an external device via a communications link. For example, data regarding authentication may include the user's date of birth, a unique number that identifies the user, whether the user has completed authentication, etc.

According to an embodiment, the processor 170 may transmit data about the status of the aerosol generating device 1 to an external device via a communication link (e.g., remaining capacity of the power supply 130, operating mode, etc.). The transmitted data may be output through a display of an external device, etc.

According to an embodiment, when a request for location search of the aerosol generating device 1 is received from an external device via a communication link, the processor 170 may control the output unit to perform an operation corresponding to the location search. For example, the processor 170 may control the haptic unit to generate vibration or control the display to output an object corresponding to the location search and search termination.

According to an embodiment, the processor 170 may perform a firmware update when firmware data is received from an external device via a communication link.

According to an embodiment, the processor 170 may transmit data on sensed values of at least one sensor unit to an external server (not shown) via a communication link, and receive and store a learning model generated by learning the sensed values through machine learning, such as deep learning, from the server. The processor 170 may perform operations such as determining a user's inhalation pattern and generating a temperature profile using a learning model received from a server.

Although not illustrated in FIG. 1, the aerosol generating device 1 may further include a power protection circuit. The power protection circuit may include at least one switching element and may cut off the current path to the power supply 130 in response to overcharge and/or overdischarge of the power supply 130.

An aerosol-generating article as described herein may include at least one aerosol-generating rod (e.g., a medium portion) and at least one filter rod. The radiating unit 30 may be arranged to correspond to at least one aerosol-generating rod, and may be designed differently depending on the arrangement order and/or position of the aerosol-generating rod and the filter rod. The aerosol-generating rod may include at least one of nicotine, an aerosol-generating material, and an additive. For example, the aerosol-generating material may include glycerin (e.g., vegetable glycerin (VG)) and/or propylene glycol (PG), and may also include various other materials. For example, the additive may include flavoring agents and/or organic acids, and may also include various other substances. For example, the aerosol-generating rod may include an aerosol-generating substrate (e.g., a sheet) impregnated with a liquid non-tobacco material (e.g., an aerosol-generating material and/or nicotine), and/or may include a solid tobacco material (e.g., leaf tobacco, reconstituted tobacco, etc.). The tobacco material may be included in the aerosol-generating rod in various forms, such as cut tobacco, granules, or powder. In an embodiment, the additive of the aerosol-generating rod may include a basic substance. Based on the basic material, the nicotine of the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, wherein the two or more aerosol-generating rods may each include tobacco material and/or non-tobacco material. Although not shown, at least one aerosol-generating rod and at least one filter rod may be individually and/or integrally wrapped by at least one wrapper. In the disclosure, the aerosol-generating article may be referred to as a stick.

The cartridge referred to in the disclosure may include an aerosol-generating material having any one of a liquid state, a solid state, a gaseous state, or a gel state therein. The aerosol-generating material may include a liquid composition. For example, the liquid composition may be a liquid including a tobacco-containing material including a volatile tobacco flavor component, or may be a liquid including a non-tobacco material. The cartridge may include a storage portion containing an aerosol-generating material and/or a liquid transfer means impregnated with (containing) the aerosol-generating material. For example, the liquid transfer medium may include a wick such as cotton fibers, ceramic fibers, glass fibers, porous ceramics, etc. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

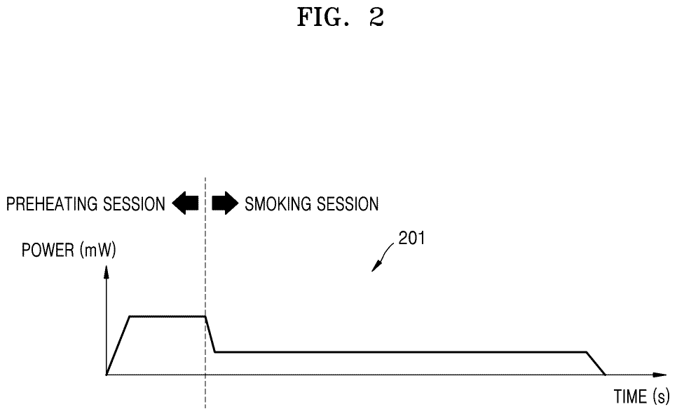

FIG. 2 is a diagram for describing a power profile according to an embodiment.

Referring to FIG. 2, a power profile 201 may represent a change in target powers supplied to the source unit 20 over time, in the aerosol generating apparatus 1. Specifically, the radiation unit 30 may regulate the intensity of electromagnetic waves (microwaves) to be radiated to an insertion space for heating of an aerosol generating article. In this case, the intensity of electromagnetic waves may be regulated by depending on an amplification level (amplification rate) of the power amplifier 230 provided in the source unit 20. For example, when the radiation unit 30 must radiate electromagnetic waves of relatively high output, the power amplifier 230 may increase the amplification rate, and when the radiation unit 30 must radiate electromagnetic waves of relatively low output, the power amplifier 230 may reduce the amplification rate, thereby regulating the intensity of electromagnetic waves to be radiated. The amplification rate by the power amplifier 230 may be changed by a magnitude of power supplied to the power amplifier 230.

According to an embodiment, the power profile 201 may correspond to a profile in which target powers preset for power to be supplied to the power amplifier 230 of the source unit 20 are predefined. Referring to the power profile 201, after an operation of the source unit 20 is initiated, in order to rapidly increase a temperature of a dielectric within the insertion space and the aerosol generating article for a predetermined time, a preheating period (or a preheating session) may be performed in which output power of the source unit 20 (power amplifier 230) is increased within a short period of time. When preheating is completed, a smoking period (or a smoking session) may be performed in which a user may take a puff. During the smoking period, a period in which a change in target power is not large may continue until the end of smoking, and it may be set such that, in the smoking period, a relatively low level of target power is maintained compared to the preheating period.

The change in target power on the power profile 201 may correspond to a change in output power of the source unit 20 (power amplifier 230), and the intensity of output electromagnetic waves (output microwaves) of the radiation unit 30 may correspond to the change in output power of the source unit 20 (power amplifier 230). The intensity of radiated electromagnetic waves may affect a degree of heating due to frictional heat of the dielectric within the aerosol generating article. Accordingly, the temperatures of the insertion space and the dielectric within the aerosol generating article during the preheating period and the smoking period may be changed to follow the trend of the change in target power on the power profile 201.

However, the power profile 201 shown in FIG. 2 merely corresponds to an arbitrary profile presented for convenience of description, and a power profile which may be used for the aerosol generating apparatus 1 is not limited by FIG. 2.

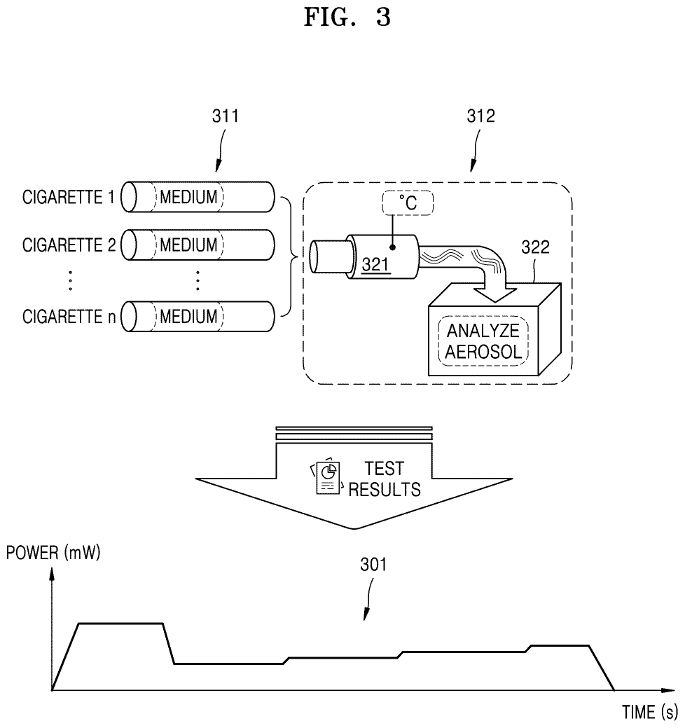

FIG. 3 is a diagram for describing a method of generating a power profile to be used in an aerosol generating apparatus, according to an embodiment.

Referring to FIG. 3, a power profile may be generated by using a test cigarette 311 and an aerosol tester 312. Here, the test cigarettes 311 may be manufactured through production processes under the same condition and may correspond to cigarettes manufactured according to the same cigarette specifications, such as the length of a cigarette, the type of medium, or the content of the medium. However, due to actual manufacturing process errors, there may be slight differences within an error range for each test cigarette 311.

The aerosol tester 312 may be a device having a heater assembly 321 manufactured in a similar structure to a heater assembly of the aerosol generating apparatus 1. The heater assembly 321 may be manufactured similar to internal and external structures provided for dielectric heating, such as the insertion space, source unit 20, and radiation unit 30 of the aerosol generating apparatus 1. The aerosol tester 312 may be a device which is operated to simulate a smoking behavior of the user when the test cigarette 311 is inserted. Specifically, the heater assembly 321 of the aerosol tester 312 has a structure having a cavity that accommodates the test cigarette 311, and may include structures and components for heating the test cigarette 311 by using electromagnetic waves (microwaves) in a dielectric heating manner, similar to the aerosol generating apparatus 1.

The aerosol tester 312 has the same smoking constraints as the aerosol generating apparatus 1 and may be operated for a preset smoking test session, such as when a predetermined time (e.g., 4 minutes and 30 seconds) has elapsed after the smoking test was initiated or until a predetermined number of puffs (e.g., 16) are reached.

The aerosol tester 312 may vary conditions of dielectric heating of the heater assembly 321 and search for an optimal power profile, so that an expected aerosol vapor amount is generated from the test cigarette 311 during the smoking test session of the test cigarette 311. Here, the conditions of dielectric heating may be conditions in which an amount of power to be supplied for each time zone is set varied during the smoking test session.

For example, when a first cigarette is inserted into the aerosol tester 312, the heater assembly 321 of the aerosol tester 312 may perform dielectric heating on a first cigarette based on a power condition. When dielectric heating is initiated, an aerosol analyzer 322 may obtain data on the amount of power supplied to the heater assembly 321 for each time zone during the smoking test session and data on the aerosol vapor amount collected by the aerosol analyzer 322. In this case, temperature data of a first cigarette or temperature data of the heater assembly 321 may be obtained through a temperature sensor installed inside the heater assembly 321 or a temperature sensor installed outside the heater assembly 321. When the smoking test for a first cigarette is ended, data on the consumption of a medium (aerosol generating material) present within a first cigarette may also be obtained separately. That is, the aerosol tester 312 may obtain various analysis data, such as an amount of aerosol vaporized (generated) or an amount of medium (aerosol generating material) consumed, from a first cigarette consumed by dielectric heating according to the first power condition.

Meanwhile, the smoking test as described above may be performed on all of the test cigarettes 311, such as a second cigarette 2, . . . an n^{th} cigarette (n is a natural number) under a second power condition, . . . an n^{th} power condition.

In the aerosol tester 312, it may be preferable that the amount of vapor in aerosol generated from the test cigarette 311 is analyzed under various dielectric heating conditions, so as to search for a power profile that generates aerosol of a uniform vapor amount throughout all periods of the smoking test session. As a result of the test, a power profile thus found may be determined as a final power profile 301.

Referring to the final power profile 301, a time it takes to reach a target preheating temperature after preheating is initiated, an amount of power supplied to reach the target preheating temperature, a time for which the temperature is maintained after the target preheating temperature is reached, an amount of power supplied to maintain the temperature after the target preheating temperature is reached, a target amount of power for each time zone during a smoking period, or the like may be set. However, the final power profile 301 shown in FIG. 3 is only an example for convenience of description, and the final power profile 301 may include power profiles of other trends.

When the final power profile 301 is obtained through the aerosol tester 312, the final power profile 301 may be stored in memory of the aerosol tester 312 as an initial power profile, for control of dielectric heating by the aerosol generating apparatus 1.

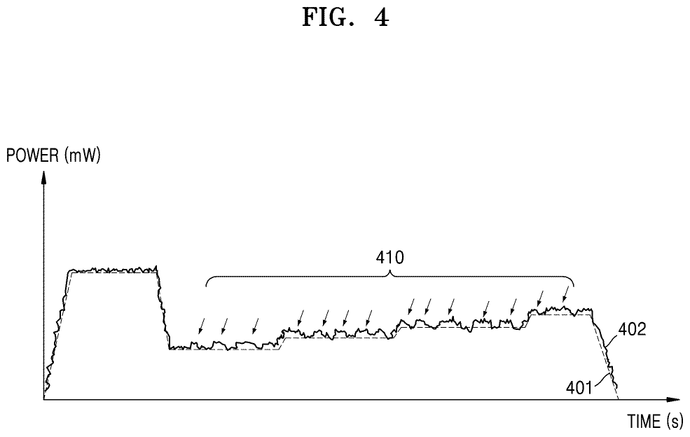

FIG. 4 is a diagram in which a preset power profile is compared with a change in a power supply during actual smoking, when dielectric heating is performed in an aerosol generating apparatus, according to an embodiment.

Referring to FIG. 4, the aerosol generating apparatus 1 may control power supply based on a preset power profile 401 while dielectric heating is performed. Here, the control of power supply may refer to controlling the intensity of electromagnetic waves (microwaves) to be output from the radiation unit 30 according to an amplification level (amplification rate) of the power amplifier 230 provided in the source unit 20, as described above.

The power profile 401 may be preset for optimal aerosol generation by the aerosol generating apparatus 1, according to the method described with reference to FIG. 3. However, the aerosol generating apparatus 1 may be operated in a different environment from the test environment conditions due to external factors, such as an inhalation strength of the user, usage pattern, or ambient temperature/humidity. Therefore, even when the optimal power profile 401 is set, target powers set in the power profile 401 may not be maintained when the actual aerosol generating apparatus 1 is operated.

An actual power change graph 402 exemplarily shows a change in actually supplied power while the aerosol generating apparatus 1 performs a smoking session by the user. According to the actual power change graph 402, it can be seen that the trend of power change during the entire period is controlled to follow the trend of a change in target power of the power profile 401. However, in sections 410 indicated by arrows, powers exceeding the target power may be supplied and then feedback control may be performed to follow the target power again.

While the aerosol generating apparatus 1 performs a smoking session using dielectric heating, the processor 170 may perform feedback control by monitoring powers actually supplied to the power amplifier 230 compared to the target powers of the power profile 401. Here, the processor 170 may perform feedback control by also monitoring powers supplied to other elements, such as the RF signal generation circuit 210, the drive amplifier 220, or the like in addition to the power amplifier 230.

Specifically, the processor 170 may monitor output of the directional coupler 240 to analyze and monitor characteristics (e.g., current, voltage, power, phase, and/or frequency) of a transmitted RF signal (radiated electromagnetic waves) and characteristics (e.g., current, voltage, power, phase, and/or frequency) of reflected electromagnetic waves. Accordingly, the processor 170 may perform feedback control on an operation of the source unit 20 based on the characteristics of the transmitted RF signal. For example, the processor 170 may adjust a frequency of an RF signal so that power of the reflected electromagnetic waves may be minimized, or may adjust an amplification rate of an RF signal by an amplifier (e.g., the power amplifier 230).

In the sections 410 indicated by arrows in the actual power change graph 402, powers exceeding the target powers are supplied, but this may be because powers different from the target power are supplied to maximize heating efficiency by the RF signal while minimizing the power of the reflected electromagnetic waves. In other words, the power profile 401 preset for the aerosol generating apparatus 1 may be slightly different from powers optimized for aerosol generation during actual operation of the aerosol generating apparatus 1. During actual operation of the aerosol generating apparatus 1, when the trend is continuously monitored in which powers different from the target power of the preset power profile 401, it may be preferable to calibrate the power profile 401.

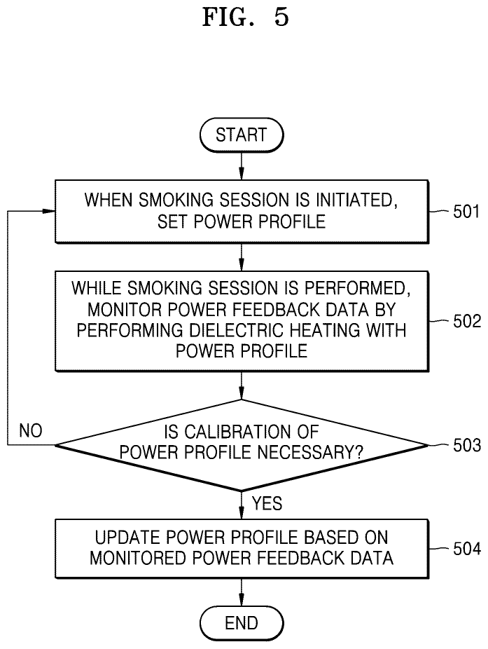

FIG. 5 is a flowchart for describing a method of calibrating a power profile, according to an embodiment.

The processor 170 may perform power feedback control based on a preset power profile while the aerosol generating apparatus 1 performs a smoking session using dielectric heating, and update the power profile when a significant difference occurs repeatedly/cumulatively between target powers of the preset power profile and powers supplied during actual operation. A process of updating the power profile is described below.

Referring to FIG. 5, in operation 501, the processor 170 may set a power profile to perform dielectric heating on an aerosol generating article, when a smoking session is initiated in the aerosol generating apparatus 1. Here, the power profile may be prestored in memory. The power profile may indicate target powers supplied to the source unit 20 and, specifically, may correspond to a profile in which target powers to be supplied to the power amplifier 230 over time are preset. However, the processor 170 may perform power control on each element of the aerosol generating apparatus 1 by also using other power profiles for controlling powers to be supplied to other elements of the control unit 10 and the source unit 20, such as the RF signal generation circuit 210 or the drive amplifier 220, in addition to the power profile for power control of the power amplifier 230.

In operation 502, during a smoking session in the aerosol generating apparatus 1, the processor 170 may monitor power feedback data by dielectric heating at the set power profile. The power feedback data may include time-based data on powers supplied to the power amplifier 230 to perform dielectric heating. For example, the power feedback data may include data on a difference between the target power on the time-based power profile and actually supplied power, data on parameters for feedback control (e.g., proportional-integral-differential (PID) control), or the like.

Meanwhile, the processor 170 may also monitor powers supplied to other elements of the control unit 10 and the source unit 20, such as the RF signal generation circuit 210 or the drive amplifier 220. The processor 170 may collect power feedback data by monitoring data on the powers supplied to other elements of the control unit 10 and the source unit 20, such as the RF signal generation circuit 210 or the drive amplifier 220.

In operation 503, when a current smoking session has ended, the processor 170 may determine whether calibration of the preset power profile is necessary, based on the collected power feedback data.

Specifically, while dielectric heating is performed based on the preset power profile, the processor 170 may analyze the number of times a voltage difference exceeding a predetermined range (power feedback margin (Δp)) occurs between the target power on the power profile and the actually supplied power, within a predetermined period, a period for which the voltage difference exceeding the predetermined range is maintained, the size of the voltage difference, a time zone in which the voltage difference occurs frequently, or the like. When a result of the analysis satisfies a predetermined condition, the processor 170 may determine that calibration of the power profile is necessary.

Here, the predetermined condition may include a case where the number of times the voltage difference occurs within the predetermined period is at least a predetermined number of times (threshold number of times), a case where the voltage difference is maintained for a predetermined period of time (threshold period of time), a case where the size of the voltage difference is at least a predetermined size (threshold size), a case where the voltage difference is repeated for each predetermined number (threshold number) of smoking sessions, or the like.

For example, a case may be assumed in which it is monitored that the power supplied to the power amplifier 230 has exceeded the target power on the power profile by at least 10 % five times within ten seconds in an arbitrary first period within the smoking period, and the same phenomenon has cumulatively occurred during five past smoking sessions. When the excessive power supply as described above repeatedly occurs in the same manner, he processor 170 may determine that calibration of the power profile is necessary.

Alternatively, when it is analyzed that a phenomenon in which the power supplied to the power amplifier 230 exceeds the target power on the power profile by at least 15 % in an arbitrary second period within the smoking period has cumulatively occurred during past three smoking sessions, the processor 170 may determine that calibration of the power profile is necessary.

That is, the predetermined condition for determining whether calibration of the power profile is necessary may be variously set, and the processor 170 may determine whether calibration of the power profile is necessary, by comparing the monitored power feedback data and the predetermined condition. When it is determined that calibration of the power profile is necessary, the processor 170 may perform operation 504. However, when it is determined that calibration of the power profile is unnecessary, the processor 170 may perform operation 501 again.

In operation 504, the processor 170 may update the power profile based on the monitored power feedback data. That is, the processor 170 may replace the previous power profile with a calibrated power profile. Accordingly, when a new smoking session has been initiated, the processor 170 may control dielectric heating based on the updated power profile.

According to the result of the determination in operation 503, the processor 170 may update, by using the power feedback data, target powers determined to require calibration from among the target powers of the previous power profile. For example, the processor 170 may calibrate the target powers in the first period of the previous power profile based on powers supplied in the first period included in the power feedback data. In this case, the processor 170 may calibrate the previous target powers as power data included in the power feedback data (i.e., 100 % reflection), or may calibrate the previous target powers by a predetermined percentage of the power data included in the power feedback data (i.e., less than 100 % reflection).

As described above, the aerosol generating apparatus 1 may customize the power profile for controlling dielectric heating to be optimized for a usage pattern of the aerosol generating apparatus 1, thereby performing more efficient control of dielectric heating and providing the user with a more enhanced aerosol smoking sensation.

In FIG. 5, a method is mainly described by which the processor 170 updates the power profile based on the power provided to the power amplifier 230. However, the disclosure is not limited thereto, and the method of FIG. 5 may also be similarly applied to methods by which the processor 170 updates power profiles for powers supplied to other elements of the control unit 10 and the source unit 20, such as the RF signal generation circuit 210 or the drive amplifier 220.

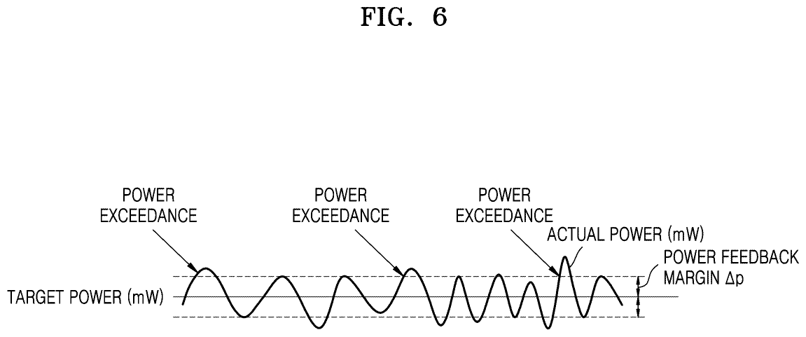

FIG. 6 is a diagram for describing a method of determining whether it is necessary to calibrate a power profile, according to an embodiment.

Referring to FIG. 6, target powers may be preset on the power profile, and the processor 170 may obtain, in real time through power monitoring, power feedback data on actual powers applied to the power amplifier 230. The processor 170 may perform feedback control such that the actual power currently supplied to the power amplifier 230 follows the target power on the power profile.

However, due to various factors, such as the usage pattern of the aerosol generating apparatus 1, an internal/external temperature of the aerosol generating apparatus 1, the characteristics of the aerosol generating article, interference between internal circuits, or battery voltage fluctuations, power that exceeds a predetermined range of the power feedback margin (Δp) may be supplied. The processor 170 may collect the power feedback data and, after the smoking session has ended, determine whether the power supply exceeding the predetermined range of the power feedback margin (Δp) is a temporary phenomenon or a phenomenon in which the predetermined condition has been met and calibration of the target power is necessary.

For example, as shown in FIG. 6, when the power feedback margin (Δp) has been exceeded at least three times during a predetermined period within the smoking period and such power exceedance occurs cumulatively in three consecutive smoking sessions, and the processor 170 may determine that calibration of the target power in the corresponding period of the power profile is necessary.

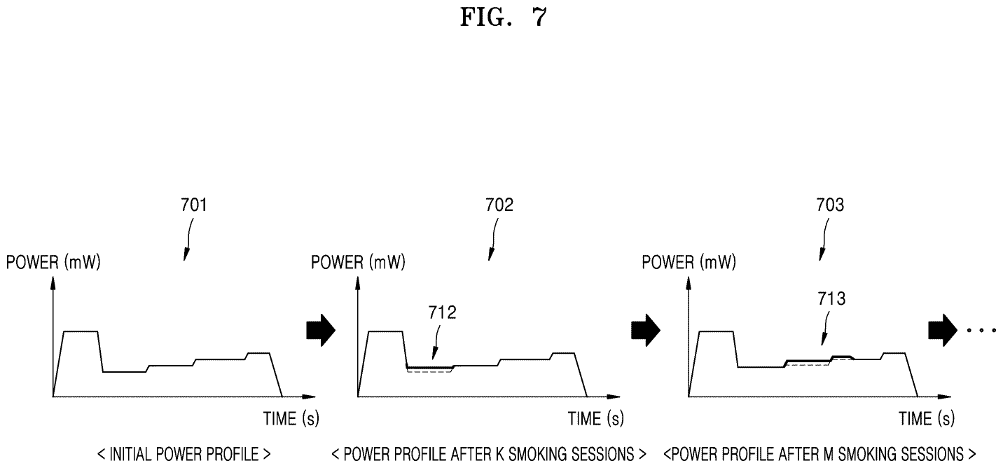

FIG. 7 is a diagram for describing a power profile that is updated through calibration, according to an embodiment.

Referring to FIG. 7, an initial power profile 701 is a power profile initially stored in the aerosol generating apparatus 1 and corresponds to a power profile for which no calibration has been performed. For example, the initial power profile 701 may correspond to a profile that is stored at the time of factory shipment of the aerosol generating apparatus 1 through test results as shown in FIG. 3.

While k (k is a natural number) smoking sessions are in progress, the processor 170 may determine that calibration of the target power of the power profile is necessary in a first period 712 within the smoking period. For example, while k smoking sessions are in progress, when, in the first period 712, a state in which the power supplied to the power amplifier 230 within ten seconds has exceeded the target power on the power profile by at least 10 % had occurred cumulatively during past five smoking sessions, the processor 170 may have determined that a predetermined condition for calibration has been met for the first period 712. Accordingly, the processor 170 may increase the target power by a predetermined amount based on the power feedback data obtained for the first period 712, so as to update the initial power profile 701 to a first power profile 702.

Thereafter, while m (m is a natural number) more smoking sessions are in progress, the processor 170 may determine that calibration of the target power of the power profile is necessary in a second period 713 within the smoking period. For example, while m more smoking sessions are in progress, in the second period 713, when a phenomenon in which the power supplied to the power amplifier 230 exceeds the target power on the power profile by at least 15 % and is maintained for at least two seconds had occurred cumulatively during past three smoking sessions, the processor 170 may have determined that a predetermined condition for calibration has been met for the second period 713. Accordingly, the processor 170 may increase the target power by a predetermined amount based on the power feedback data obtained for the second period 713, so as to update the first power profile 702 to a second power profile 703.

As described above, while the aerosol generating apparatus 1 is used continuously, the processor 170 may constantly monitor the power difference between the power profile currently used and the power actually supplied to the power amplifier 230 for dielectric heating, so as to perform an update to a new power profile by using the power feedback data when calibration of the power profile is necessary. Accordingly, the aerosol generating apparatus 1 may control dielectric heating according to the power profile optimized for a usage pattern and generate an aerosol from an aerosol generating article, thereby providing the user with a more enhanced smoking sensation.

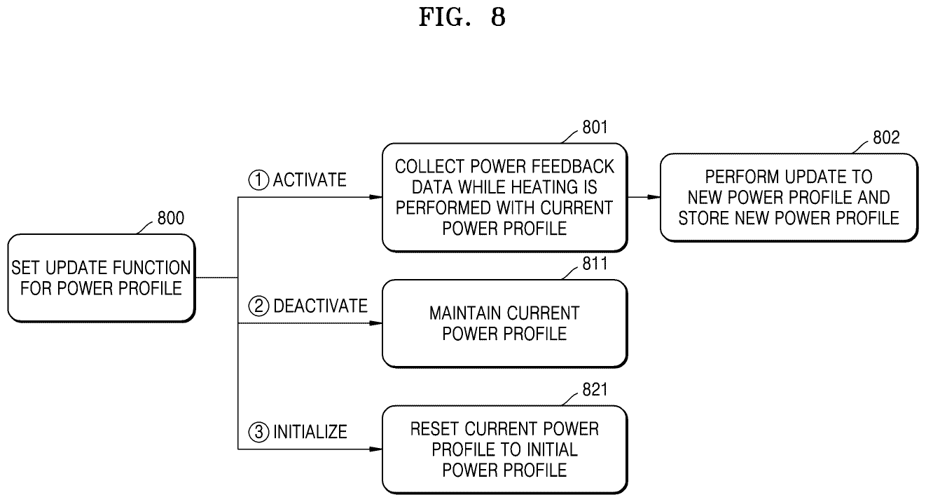

FIG. 8 is a diagram for describing a method of setting an update function for a power profile, according to an embodiment.

Referring to reference numeral 800 of FIG. 8, the aerosol generating apparatus 1 may set an update function for a power profile. For example, the update function for the power profile may be selected as one of an activate, deactivate, and initialize.

Referring to reference numeral 801, when a smoking session is initiated while the update function for the power profile is activated, the aerosol generating apparatus 1 may collect power feedback data while dielectric heating is performed with a current power profile. Referring to reference numeral 802, when an update of the previous power profile is necessary, the aerosol generating apparatus 1 may update the previous power profile to a new power profile based on the collected power feedback data and store the updated power profile. That is, the update of the power profile may be performed according to the process described above with reference to FIGS. 4 to 7.

Referring to reference numeral 811, when a smoking session is initiated while the update function for the power profile is deactivated, the aerosol generating apparatus 1 may perform dielectric heating with the currently set power profile. However, also in this case, the aerosol generating apparatus 1 may constantly collect power feedback data.

Referring to reference numeral 812, when a function of initializing a power profile is set, the aerosol generating apparatus 1 (processor 170) may reset the current power profile to the initially stored power profile. That is, the aerosol generating apparatus 1 may perform dielectric heating using the initial power profile again from a smoking session thereafter.

Meanwhile, the update function for the power profile may be set and changed by the user through an input unit provided in the aerosol generating apparatus 1.

The above-described effects of the present embodiments are examples, and are not limited to those described above, and may vary. In addition, the disclosure may also be implemented with features described below. Various features of various embodiments may include various combinations by including some features and excluding other features, to suit various different applications.

Embodiment 1: an aerosol generating apparatus includes a source unit configured to generate a microwave signal to perform dielectric heating on an aerosol generating article by using microwaves, and a control unit configured to control an intensity of the microwave signal by controlling powers to be provided from a power source to the source unit, wherein the control unit includes a processor, which is configured to monitor power feedback data on powers provided to the source unit while the dielectric heating is performed with a preset power profile during a smoking session, and to update the power profile based on the monitored power feedback data when calibration of target powers of the power profile is necessary.

Embodiment 2: In the aerosol generating apparatus of Embodiment 1, the processor determines whether the calibration is necessary, by analyzing data on a power difference between the target powers of the power profile and the powers provided to the source unit, from the monitored power feedback data.

Embodiment 3: In the aerosol generating apparatus of Embodiment 2, the data on the power difference includes at least one of a number of times a power difference between the target powers and the powers provided to the source unit has exceeded a predetermined range, a period for which the power difference exceeding the predetermined range is maintained, a size of the power difference, and a time zone in which the power difference occurred frequently.

Embodiment 4: In the aerosol generating apparatus of Embodiment 3, the processor determines that the calibration is necessary when the analyzed data on the power difference satisfies a predetermined condition, and updates the power profile.

Embodiment 5: In the aerosol generating apparatus of Embodiment 4, the predetermined condition includes at least one of a case where a number of times the power difference occurred in a predetermined period is at least a predetermined number, a case where the power difference is maintained for a predetermined period of time, a case where the size of the power difference is at least a predetermined size, and a case where the power difference is repeated for a predetermined number of smoking sessions.

Embodiment 6: In the aerosol generating apparatus of Embodiment 1, the processor calibrates target powers determined to require the calibration from among the target powers of the power profile, by using power data included in the power feedback data, and update the power profile.

Embodiment 7: In the aerosol generating apparatus of Embodiment 1, the power feedback data includes data on powers actually supplied to a power amplifier provided in the source unit.

Embodiment 8: A method of controlling an aerosol generating apparatus includes, when a smoking session is initiated, setting a power profile to perform dielectric heating on an aerosol generating article by using microwaves, monitoring power feedback data on powers provided to a source unit configured to generate a microwave signal, while the dielectric heating is performed with the set power profile during the smoking session, when the smoking session has ended, determining whether calibration of the power profile is necessary, based on the monitored power feedback data, and when it is determined that the calibration of the power profile is necessary, updating the power profile based on the monitored power feedback data.

Embodiment 9: In the method of Embodiment 8, the determining includes determining whether the calibration is necessary by analyzing data on a power difference between target powers of the power profile and the powers provided to the source unit, from the monitored power feedback data.

Embodiment 10: In the method of Embodiment 9, the data on the power difference includes at least one of a number of times a power difference between the target powers and the powers provided to the source unit has exceeded a predetermined range, a period for which the power difference exceeding the predetermined range is maintained, a size of the power difference, and a time zone in which the power difference occurred frequently.

Embodiment 11: In the method of Embodiment 10, the determining includes determining that the calibration is necessary when the analyzed data on the power difference satisfies a predetermined condition, and the predetermined condition includes at least one of a case where a number of times the power difference occurred in a predetermined period is at least a predetermined number, a case where the power difference is maintained for a predetermined period of time, a case where the size of the power difference is at least a predetermined size, and a case where the power difference is repeated for a predetermined number of smoking sessions.

Embodiment 12: In the method of Embodiment 8, the updating includes calibrating target powers determined to require the calibration from among target powers of the power profile, by using power data included in the power feedback data, and updating the power profile.

Embodiment 13: In the method of Embodiment 8, the power feedback data includes data on powers actually supplied to a power amplifier provided in the source unit.

Embodiment 14: A non-transitory computer-readable storage medium having recorded thereon a program for executing the method of any one of Embodiments 8 to 13, on a computer may be provided.

Certain embodiments or other embodiments of the disclosure described above are not exclusive or distinct from each other. The certain embodiments or other embodiments of the disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictively and should be considered illustrative, in all aspects. The scope of the disclosure should be determined by a rational interpretation of the attached claims, and all changes within the equivalent scope of the disclosure are included in the scope of the disclosure.

According to the embodiments described above, when calibration of a power profile currently used in an aerosol generating apparatus is necessary, an update to a new power profile may be performed. Accordingly, an aerosol may be generated by controlling dielectric heating with a power profile that is optimized for a usage pattern of the aerosol generating apparatus, thereby efficiently controlling the dielectric heating and providing a user with a more enhanced smoking sensation.

What is claimed is:

1. An aerosol generating apparatus comprising:
a source unit configured to generate a microwave signal to perform dielectric heating on an aerosol generating article by using microwaves; and
a control unit configured to control an intensity of the microwave signal by controlling powers to be provided from a power source to the source unit,
wherein the control unit includes a processor, which is configured to monitor power feedback data on powers provided to the source unit while the dielectric heating is performed with a preset power profile during a smoking session, and to update the power profile based on the monitored power feedback data when calibration of target powers of the power profile is necessary.

2. The aerosol generating apparatus of claim 1, wherein the processor is further configured to determine whether the calibration is necessary, by analyzing data on a power difference between the target powers of the power profile and the powers provided to the source unit, from the monitored power feedback data.

3. The aerosol generating apparatus of claim 2, wherein the data on the power difference includes at least one of a number of times a power difference between the target powers and the powers provided to the source unit has exceeded a predetermined range, a period for which the power difference exceeding the predetermined range is maintained, a size of the power difference, and a time zone in which the power difference occurred frequently.

4. The aerosol generating apparatus of claim 3, wherein the processor is further configured to determine that the calibration is necessary when the analyzed data on the power difference satisfies a predetermined condition, and update the power profile.

5. The aerosol generating apparatus of claim 4, wherein the predetermined condition includes at least one of a case where a number of times the power difference occurred in a predetermined period is at least a predetermined number, a case where the power difference is maintained for a predetermined period of time, a case where the size of the power difference is at least a predetermined size, and a case where the power difference is repeated for a predetermined number of smoking sessions.

6. The aerosol generating apparatus of claim 1, wherein the processor is further configured to calibrate target powers determined to require the calibration from among the target powers of the power profile, by using power data included in the power feedback data, and update the power profile.

7. The aerosol generating apparatus of claim 1, wherein the power feedback data includes data on powers actually supplied to a power amplifier provided in the source unit.

8. A method of controlling an aerosol generating apparatus, the method comprising:
when a smoking session is initiated, setting a power profile to perform dielectric heating on an aerosol generating article by using microwaves;
monitoring power feedback data on powers provided to a source unit configured to generate a microwave signal, while the dielectric heating is performed with the set power profile during the smoking session;
when the smoking session has ended, determining whether calibration of the power profile is necessary, based on the monitored power feedback data; and
when it is determined that the calibration of the power profile is necessary, updating the power profile based on the monitored power feedback data.

9. The method of claim 8, wherein the determining includes determining whether the calibration is necessary by analyzing data on a power difference between target powers of the power profile and the powers provided to the source unit, from the monitored power feedback data.

10. The method of claim 9, wherein the data on the power difference includes at least one of a number of times a power difference between the target powers and the powers provided to the source unit has exceeded a predetermined range, a period for which the power difference exceeding the predetermined range is maintained, a size of the power difference, and a time zone in which the power difference occurred frequently.

11. The method of claim 10, wherein the determining includes determining that the calibration is necessary when the analyzed data on the power difference satisfies a predetermined condition, and
the predetermined condition includes at least one of a case where a number of times the power difference occurred in a predetermined period is at least a predetermined number, a case where the power difference is maintained for a predetermined period of time, a case where the size of the power difference is at least a predetermined size, and a case where the power difference is repeated for a predetermined number of smoking sessions.

12. The method of claim 8, wherein the updating includes calibrating target powers determined to require the calibration from among target powers of the power profile, by using power data included in the power feedback data, and updating the power profile.

13. The method of claim 8, wherein the power feedback data includes data on powers actually supplied to a power amplifier provided in the source unit.

14. A non-transitory computer-readable storage medium having recorded thereon a program for executing the method of claim 8, on a computer.
